(19) United States
(12) Patent Application Publication
(10) Pub. No.: US 2017/0036726 A1
(43) Pub. Date: Feb. 9, 2017

(54) Smartwatch Holder

(71) Applicant: Canyon Bicycles GmbH, Koblenz (DE)

(72) Inventors: Sebastian Fitz, Ellern (DE); Sebastian Wegerle, Koblenz (DE)

(21) Appl. No.: 15/229,483

(22) Filed: Aug. 5, 2016

(30) Foreign Application Priority Data
Aug. 6, 2015 (DE) 20 2015 005 452.8

(51) Int. Cl. B62J 9/00

(52) U.S. Cl. CPC B62J 9/003

(57) ABSTRACT

A smartwatch holder for accommodating a smartwatch at a bicycle, in particular at a handlebar or a stem, includes a fastening arrangement and a fixing arrangement. The fastening arrangement serves for fastening to a handlebar. The fixing arrangement includes holding elements which cooperate with wristband accommodation portions provided at a housing of the smartwatch for fixing purposes. An energy store, such as an accumulator, may be provided in a base element of the fixing arrangement.

### CROSS-REFERENCE TO RELATED APPLICATION

This application claims priority to German Patent Application No. 20 2015 005 452.8 filed Aug. 6, 2015, the disclosure of which is hereby incorporated in its entirety by reference.

### BACKGROUND OF THE INVENTION

Field of the Invention

The present invention relates to a smartwatch holder for arranging a smartwatch at a bicycle, in particular at a handlebar or a stem of a bicycle.

Description of Related Art

For smartphones, a plurality of apps exist which by now offer a very large scope of functions and different services. Further, apps suitable for biking purposes are on offer for smartphones. Such apps include the usual functions of a bicycle computer, in particular the determination of the current velocity, the average velocity etc. Further, apps are known with the aid of which a bicycle tour can be recorded and/or planned, for example. For this purpose, the GPS function of the smartphone is used in most cases. In addition, smartwatches are on offer now. They communicate with a smartphone and serve as a second screen of the smartphone, which screen is adapted to be worn at the wrist like a watch.

### SUMMARY OF THE INVENTION

It is an object of the present invention to improve the use of smartwatches in the field of biking.

The smartwatch holder according to the invention serves for arranging a smartwatch at a bicycle, in particular at a handlebar or a stem. For this purpose, the smartwatch holder includes a fastening means, also referred to as a fastening arrangement, which is fastened to the bicycle. Further, the smartwatch holder includes a fixing means, also referred to as a fixing arrangement, connected with the fastening means. The fixing means serves for accommodating the smartwatch. For this purpose, the fixing means includes at least one holding element. The at least one holding element is configured such that it cooperates with a housing of the smartwatch such that the smartwatch is held in the fixing means without a wristband. Particularly preferably, the at least one holding element of the fixing means engages with a wristband accommodating portion of the housing and/or cooperates with the latter. According to a preferred aspect, in a first step the wristband is thus removed from the housing of the smartwatch for fastening the smartwatch to the fixing means of the smartwatch holder. Subsequently, the smartwatch can easily be arranged at the fixing means in that the at least one holding element engages with the wristband accommodating portion.

In addition, preferably two holding elements are provided which in particular are arranged opposite to each other at the fixing means. Preferably, for fixing the smartwatch, the two holding elements engage with the two wristband accommodating portions provided at the housing of the smartwatch. In addition, preferably at least one of the holding elements is elastic such that the smartwatch can easily be pressed into the holder and at least one of the holding elements in particular snaps in place in the wristband accommodating portion. Of course, similarly configured latch elements may be provided. For example, the at least one holding element could thus be configured such that it cooperates with a holding element provided at the lower side of the smartwatch.

Further, an additional housing lid could be provided as a holding element, which housing lid holds the smartwatch at the fixing means. The smartwatch would then be arranged in a kind of additional housing.

When the smartwatch is used on a bicycle as intended by the invention, a problem arises in that, in particular during an extended use of preferably several hours, the accumulators provided in the smartwatch are not designed for such a long and intensive employment. It must be taken into account that during use of the smartwatch as a bicycle computer data are continuously received by the smartwatch or transmitted by the smartwatch to the smartphone, if required, which entails high energy consumption. In a particularly preferred aspect of the smartwatch holder the latter hence includes an energy store. The energy store may be connected with the fastening means and/or the fixing means. Preferably, the energy store is at least one rechargeable accumulator. Alternatively, an exchangeable battery may be provided as an energy store.

In a preferred aspect, the fixing means includes an electric connector connected with the energy store. Said electric connector serves for supplying the smartwatch with energy. The electric connector may be a plug contact. Said plug contact can be connected via an additional cable with the smartwatch. Preferably, the electric connector is provided at the fixing means such that, when the smartwatch is connected with the at least one holding element of the fixing means, the electric connector connected with the energy store is automatically connected with an electric connector of the smartwatch.

In addition, it is possible not to provide a plug contact as the electric connector but to realize the energy transfer by induction.

The energy store, which preferably is an accumulator, may be arranged in a compartment of the smartwatch holder or be connected via an accommodation element with the smartwatch holder. For charging the accumulator, the latter can easily be removed from the smartwatch holder and charged.

Preferably, the accumulator is integrated in this smartwatch holder, in particular in the fixing means of the smartwatch holder. It is hence further preferred that a charging connector is connected with the energy store. Said connector is a mini USB connector, for example, for connecting the accumulator with a power source for charging purposes. The charging process of the energy store can also be performed by induction and a correspondingly configured charging connector.

In particular in the aspect of the present invention where the accumulator is integrated in the fixing means it is preferred that the fixing means is releasably and not integrally connected with the fastening means. This configuration allows for the fixing means to be detached together with the accumulator in a simple manner for charging purposes. The connection between the fastening means and the fixing means is preferably realized via an easy-to-release connection, such as a latch connection, a bayonet catch or the like.

The fastening means of the smartwatch holder includes a clamp, for example, for realizing simple fastening to a handlebar. For fastening to a stem, the fastening means may be configured such that it includes one or a plurality of recesses for accommodating screws. Those screws may be used with the aid of which the stem cap for fixing the handlebar is fixed. It may merely be necessary to use longer screws.

### BRIEF DESCRIPTION OF THE DRAWINGS

Hereunder a preferred aspect of the present invention is described in detail with reference to the drawings in which:

FIG. 1 shows a schematic top view of a preferred aspect of the smartwatch holder, and

FIG. 2 shows a schematic side view of the smartwatch holder illustrated in FIG. 1 along with a smartwatch.

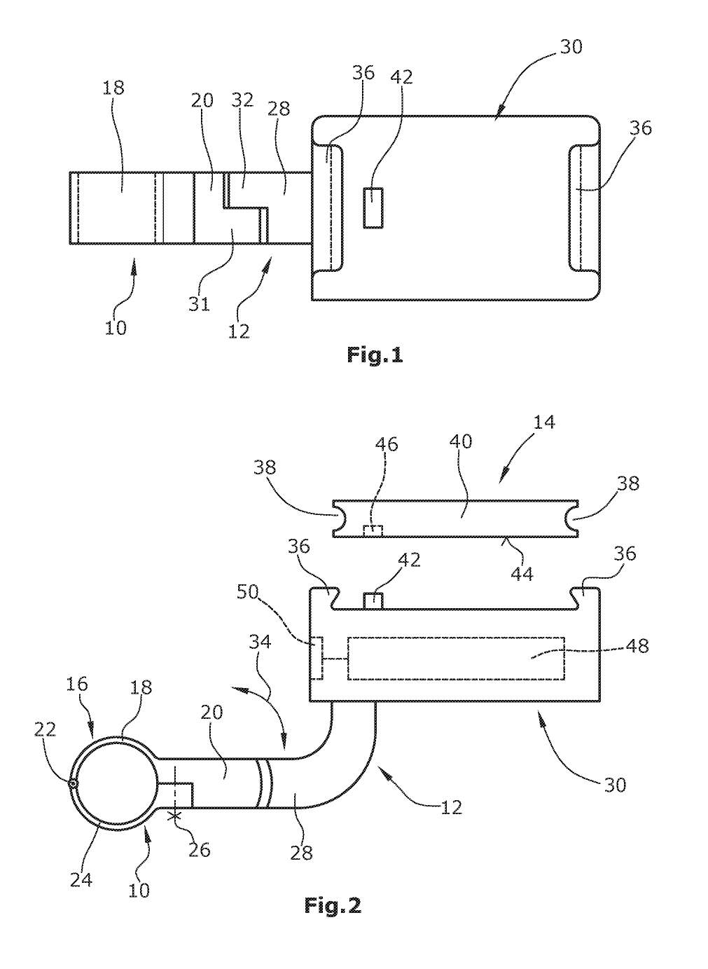

### DETAILED DESCRIPTION OF THE INVENTION

In the illustrated aspect, the smartwatch holder includes a fastening means 10 (also referred to as a fastening arrangement) for fastening to a handlebar. The fastening means 10 has connected therewith a fixing means 12 (also referred to as a fixing arrangement). The fixing means 12 serves for accommodating a smartwatch 14. In the illustrated exemplary aspect, the fastening means 10 includes a clamp 16. A first clamp element 18 is fixedly connected with an arm 20 of the fastening means 10. A second clamp element 24 is pivotally connected via a hinge 22 with the first clamp element 18. The clamp can be closed with the aid of a schematically illustrated screw 26. Alternatively, latch element may be provided.

The fixing means 12 includes an arm 28 which is fixedly connected with a base element 30 of the fixing means in the illustrated exemplary aspect. The arm 28 of the fixing means 12 is connected with the arm 20 of the fastening means. In a preferred aspect, this connection is a releasable connection. In the illustrated exemplary aspect, the two arms 20, 28 include projections 31, 32 which are arranged opposite to each other. The connection can be realized at the contact surfaces of the two projections 31, 32 via latch elements, a bayonet catch or the like, for example. In particular, it is possible to provide latch elements with the aid of which the two arms 20, 28 can be connected with each other in different positions such that the inclination of the fixing means 12 and thus the smartwatch 14 can be changed in a simple manner in the direction indicated by an arrow 34.

In the illustrated exemplary aspect, the base element 30 of the fixing means 12 includes two holding elements 36 arranged opposite to each other, wherein at least one of the two holding elements 36 is elastic. For fixing the smartwatch 14 at the base element 30, the nose-shaped projections of the holding elements 36 each engage with recesses 38 arranged opposite to each other at a housing 40 of the smartwatch 14. In particular, the recesses 38 are wristband accommodating portions serving for connecting a wristband with the smartwatch 14.

In the illustrated exemplary aspect, an electric connector 42 is arranged between the two holding elements 36. Said electric connector is an electric plug, for example. When the smartwatch 14 is connected with the base element 30 the electric plug is automatically inserted into a plug contact 46 provided at a lower side 44 of the smartwatch 14.

The electric contact 42 is connected with an energy store, such as an accumulator 48. Thus it is possible to use the smartwatch 14 as a bicycle computer over a long period, for example. For charging the accumulator 48 another electric connector 50 is provided at the base element 30. In the illustrated exemplary aspect, the arm 28 of the fixing means 12 can be detached in a simple manner from the arm 20 of the fastening means 10 such that it is possible to charge the accumulator 48 in a simple manner.

Although the invention has been described and illustrated with reference to specific illustrative embodiments thereof, it is not intended that the invention be limited to those illustrative aspects. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A smartwatch holder for arranging a smartwatch at a bicycle, comprising:
a fastening arrangement for fastening to a bicycle, and
a fixing arrangement connected with said fastening arrangement and adapted for accommodating said smartwatch,
wherein said fixing arrangement comprises at least one holding element which cooperates with a housing of said smartwatch for holding said smartwatch at said fixing arrangement without a wristband.

2. The smartwatch holder according to claim 1, wherein the at least holding element engages with at least one wristwatch accommodating portion provided at the housing of the smartwatch.

3. The smartwatch holder according to claim 1, wherein an energy store, connected with the fixing arrangement and/or the fastening arrangement is provided.

4. The smartwatch holder according to claim 3, wherein the fixing arrangement comprises an electric connector connected with the energy store for supplying energy to the smartwatch.

5. The smartwatch holder according to claim 4, wherein the electric connector is arranged at the fixing element such that, when the smartwatch is connected with the at least one holding element, said electric connector of said fixing arrangement is automatically connected with an electric connector of said smartwatch.

6. The smartwatch holder according to claim 3, wherein a charging connector connected with the energy store is provided for charging the energy store.

7. The smartwatch holder according to claim 1, wherein the fixing arrangement is releasably connected with the fastening arrangement.

8. The smartwatch holder according to claim 1, wherein the fastening arrangement comprises a clamp for fastening to a handlebar.

9. The smartwatch holder according to claim 1, wherein the fastening arrangement comprises recesses for accommodating screws.
